(19) United States
(12) Patent Application Publication
(10) Pub. No.: US 2004/0254770 A1
(43) Pub. Date: Dec. 16, 2004

(54) Fast assignment of partial atomic charges

(76) Inventors: Michael Kenneth Gilson, Gaithersburg, MD (US); Michael Jason Potter, North Potomac, MD (US); Hilary Sue Rodman Gilson, Gaithersburg, MD (US)

Correspondence Address: CROWELL & MORING LLP, INTELLECTUAL PROPERTY GROUP, P.O. BOX 14300, WASHINGTON, DC, 20044-4300, US

(21) Appl. No.: 10/863,234

(22) Filed: Jun. 9, 2004

Related U.S. Application Data
(60) Provisional application No. 60/477,322, filed on Jun. 11, 2003.
(60) Provisional application No. 60/477,342, filed on Jun. 11, 2003.

(51) Int. Cl. G06F 17/10

(52) U.S. Cl. 703/2

(57) ABSTRACT

The present invention addresses the need for a fast, accurate and broadly applicable method of computing accurate partial atomic charges in the context of molecular calculations. The method uses the electronegativity equalization approach and is parameterized to reproduce ab initio molecular electrostatic potentials. It uses a new algorithm to ensure correct treatment of molecules having multiple resonance forms that contribute significantly to the electronic structure. The method will be useful in a variety of computational chemistry applications, including structure-based drug design, and the algorithm for identifying alternate resonance forms of molecules has additional applications in molecular modeling and chemical informatics.

### CROSS-REFERENCE TO RELATED APPLICATIONS

The present application claims priority to U.S. Provisional Application No. 60/477,322 filed Jun. 6, 2003 and U.S. Provisional Application No. 60/477,342 also filed on Jun. 6, 2003. The contents of the Applications are incorporated by refenced in their entirety.

### STATEMENT REGARDING FEDERALLY SPONSORED RESEARCH OR DEVELOPMENT

This invention was made with government support under grants GM062050, “Inexpensive, Interactive Molecular Modeling Software” and GM61300, “Theory and Modeling of Noncovalent Binding”, awarded by the NIH. The United States government has certain rights in the invention.

### BACKGROUND OF THE INVENTION

Computational molecular modeling is widely used in the pharmaceutical, chemical and biotechnology industries to aid in the interpretation of experimental data and in the design of chemical compounds for use as therapeutic agents, catalysts, encapsulating agents, etc. The usage, importance, and commercial value of molecular modeling in such activities has increased steadily over the last two decades. Major pharmaceutical and chemical companies use molecular modeling software, and there are currently a number of companies whose business centers around creation and publication of molecular modeling software to industrial and academic research organizations. The market for molecular modeling software is likely to continue increasing for at least another 10 to 20 years, due in part to improvements in molecular modeling algorithms and software, and also to continued growth in the power and the performance-to-price ratio of computer hardware.

Most molecular modeling techniques rely upon an energy model, or force field, which yields the energy of a molecule, or a complex consisting of multiple molecules, as a function of its conformation. (See, for example, Weiner, S. J, et al., J. Am. Chem. Soc. 1984, 106:765-784 and MacKerell, Jr., A. D., et al., J. Am. Chem. Soc. 1995, 117:11946-11975.) The energy contributions in a force field can be separated into bonded terms that account for bond-stretches, angle-bends and torsional bond-rotations; and nonbonded terms, which are typically treated as a sum of Lennard-Jones terms and electrostatic interactions. The electrostatic interactions are computed based upon the interatomic distances and the partial atomic charges assigned by the force field. Thus, each atom in the molecule is assigned a partial atomic charge, typically in the range −1 to +1 elementary charges, whose value reflects the polarity and, more particularly, the relative electronegativity of the atom, as well as its specific bonding environment in the molecule. For example, the oxygen and carbon making up a carbonyl group might be assigned partial atomic charges of about −0.4 and +0.4 elementary charges, respectively. The electrostatic interactions among these charges can account not only for general electrostatic interactions, but also for hydrogen bonding.

The electrostatic part of the force field is of critical importance in molecular modeling, playing a central role in determining molecular conformations and intermolecular binding affinities. However, although carefully adjusted and tested partial atomic charges are available for common biomolecular components, such as amino acids and nucleic acids, it can be difficult to obtain accurate partial charges for the wide variety of chemistries found in synthetic compounds, such as drug candidates and synthetic hosts. This difficulty poses a particular problem when molecular modeling is used for molecular design, because the user is then proposing and studying compounds that have never been modeled or synthesized before.

One of the most widely accepted approaches to generating physically reasonable partial atomic charges for new compounds involves fitting the charges to electrostatic potentials (ESPs) computed with ab initio quantum mechanics at sampling points around the molecule. (See, e.g., Momany, F., J. Phys. Chem. 1978, 82;592.) These ESP methods are general, are well-founded theoretically, and have been shown to generate useful results. However, they require minutes to hours of computer time for each molecule, so they are cumbersome for interactive molecular design and too slow for processing catalogs and databases containing thousands or millions of compounds. Also, ESP charges depend upon the conformation of the molecule used in fitting the charges, partly because changes in conformation truly do change the spatial distribution of electrons relative to the atomic nuclei, and partly because changes in conformation alter the distribution of sampling points in the ESP calculation. Of particular concern is that the ESP method frequently assigns different charges to chemically equivalent atoms, such as the three hydrogens of a methyl group, while force-field based modeling almost always requires that equivalent atoms be assigned equal charges. The Restrained Electrostatic Potential (RESP) method addresses these problems by using ab initio quantum mechanics and ESP methods to compute partial atomic charges for multiple molecular conformations, and then averaging the resulting charges over the conformations and also over chemically equivalent atoms. (See, e.g., Bayly, C. I. et al., J. Phys. Chem. 1993, 97;10269-10280.) However, the additional steps in the RESP procedure impose additional computational demands, and also pose the nontrivial problems of identifying chemically equivalent atoms and selecting representative conformations.

An alternative is to use rule-based methods, which classify atoms into types based upon their bonding environments and assign charges accordingly (e.g., Momany, F. A. and Rone, R. J. Comput. Chem. 1992, 13;888-900.) This approach is fast and accurate when sufficiently specific atom types are available in the parameter set. However, complex atom-typing algorithms may be required and, more importantly, it is difficult to establish a set of types that is large enough to accommodate the diverse chemistries that are encountered in many commercial applications. As a consequence, these methods often do not have specifically parameterized charges for all atoms in a molecule and are thus forced to drop back to general or default atom types that are not well parameterized. Also, there is no guarantee that the charges these methods assign to the atoms in a molecule will sum to the correct total charge. This problem has been addressed by determining the difference between the net assigned charge of the molecule and the correct net charge, and repairing the assigned charges by spreading the required difference charge uniformly over some or all of the atoms. This approach formally solves the problem, but is not physically motivated and may introduce error.

A closely related approach is to use bond-charge increments, which place net-neutral dipoles across bonds based upon the types of the atoms involved. (See, e.g., Bush, B. L. et al., J. Comput. Chem. 1999, 20:1495-1516.) For example, a bond-charge increment of 0.2 elementary charges (e) would add a charge of −0.2 e to the atom on one end of the bond, and a charge of +0.2 e to the atom on the other end of the bond. Such methods are fast, but again require complex atom-typing algorithms and drop back to generalized default parameters when atoms or bonds are encountered that lie beyond the existing types. In addition, the bond-charge increment methods are not based upon a well-defined physical model and, probably for this reason, are subject to error. This has motivated the development of hybrid approaches, such as those described in Jakalian, A. et al, J. Comput. Chem. 2000, 21: 132-146 and in Storer, J. W. et al., J. Comput. Aided Mol. Des. 1995, 9:87, in which atomic charges computed with semi-empirical quantum methods such as AM1 (Dewar, M. J. S. et al., J. Am. Chem. Soc. 1985, 107;3902-3909) are then modified via parameterized bond-charge increments. This important approach markedly improves accuracy, but at the cost of computational performance, since semi-empirical quantum calculations are time-consuming. It would thus be difficult to use such methods to calculate charges for very large numbers of compounds, or in interactive applications that aim to provide a quick response time.

Another approach to assigning partial atomic charges uses the concept of equalization of electronegativities (Sanderson, R. T. Science 1951, 114: 670). Such methods quantify the idea that highly electronegative atoms, such as oxygens, draw electrons away from less electronegative atoms, such as carbons. These methods are appealing because they are fast, are based upon a reasonable physical picture, and can be transferred across a broad range of molecules without the need to define a large number of different atom types. However, as detailed below, existing electronegativity equalization methods often generate charges that disagree markedly with the touchstone ab initio ESP calculations described above. In addition, the treatment of formal charges has been problematic. Thus, the pioneering work of Gasteiger and Marsili, Tetrahedron 1980, 36:3219-3228, does not define a method of treating ionized groups and, as noted in Halgren et al., J. Comput. Chem. 1996, 17;520-552, the charges assigned to ionized groups by the QEq electronegativity equalization method (Rappe, A. K. and Goddard III, W. A. J. Phys. Chem. 1991, 95, 3358-3363) tend to be unrealistically small. Very recently, Bultinck et al, Phys. Chem. A 2002, 106:7887-7894, presented an electronegativity equalization method parameterized to match charges obtained by Mulliken or natural population analysis of quantum calculations; the method was reported to be less accurate when adjusted in relation to ESPs. As in the case of QEq, the charges depend upon molecular conformation, so computing charges for a large compound database would require generating a reasonable three-dimensional conformation for each compound. Also, in the method of Bultinck and coworkers, ionic groups are not specifically considered and the training and test sets do not appear to include any ions. It is thus of concern that this method, like QEq, yields inaccurate partial atomic charges for ionic compounds.

Another problem with existing methods of assigning partial atomic charges concerns the fact that the computer representation of a molecule normally represents only a single resonance form, even though other resonance forms may be equally important in determining the molecule's electronic structure and hence its properties, including its partial atomic charges. Except for the purely quantum mechanical methods, existing methods of assigning partial atomic charges do not include an adequate, automated way of handling molecules with alternate resonance forms, and failing to consider alternate resonance forms can lead to substantial errors. As a very simple example, including only one resonance form of a carboxylate group (FIG. 1) will lead to assigning very different partial atomic charges to the two oxygen atoms, even though both oxygens are chemically equivalent. Correctly including both resonance forms of the carboxylate would avoid this error. An automated method for discovering alternate resonance forms would also have broader applications of its own. For example, because the computer representation of a molecule can be in any one of multiple resonance forms, a method of discovering alternate resonance forms would be useful in determining whether two different computer representations actually define the same molecule.

Thus, there is still a need for a fast, accurate and broadly applicable method of computing accurate partial atomic charges, and such a method will in turn require a method for automatically identifying alternate resonance forms of molecules.

### BRIEF SUMMARY OF THE INVENTION

The present invention provides a method of assigning charges to atoms in a molecule in the context of carrying out a molecular calculation, comprising, for each atom i in the molecule, assigning an electrical charge qᵢ by minimizing a function E according to Equation 1 as follows:

$$E = {\sum }_{i} ( {e}_{i} {q}_{i} + \frac{1}{2} {s}_{i}^{o} {q}_{i}^{2} ) \qquad Equation 1$$

wherein eᵢ is the electronegativity of atom i, sᵢ^{o} is the hardness of atom i and the summation runs over all atoms in the molecule and wherein eᵢ is calculated according to Equation 2

$${e}_{i} = {e}_{i}^{o} + {α}_{1} {\sum }_{j}^{{N}_{s}} {S}_{ij} {\vert {e}_{i}^{o} - {e}_{j}^{o} \vert}^{β} + {α}_{2} {\sum }_{k}^{{N}_{d}} {S}_{ik} {\vert {e}_{i}^{o} - {e}_{k}^{o} \vert}^{β} + {α}_{3} {\sum }_{l}^{{N}_{t}} {S}_{il} {\vert {e}_{i}^{o} - {e}_{l}^{o} \vert}^{β} + {α}_{4} {\sum }_{m}^{{N}_{a}} {S}_{im} {\vert {e}_{i}^{o} - {e}_{m}^{o} \vert}^{β} + {α}_{5} {\sum }_{n}^{{N}_{1 - 3}} {S}_{i n} {\vert {e}_{i}^{o} - {e}_{n}^{o} \vert}^{β} \qquad Equation 2$$

wherein

$${S}_{ab} ≡ \frac{{e}_{a}^{o} - {e}_{b}^{o}}{\vert {e}_{a}^{o} - {e}_{b}^{o} \vert} ,$$

and wherein eᵢ^{o} is a predetermined initial electronegativity for atom i; α₁, α₂, α₃, α₄, α₅ and β are fitted parameters; Nₛ denotes the total number of atoms j linked to atom i by a single bond, N_{d} denotes the total number of atoms k linked to atom i by a double bond, Nₜ denotes the total number of atoms l linked to atom i by a triple bond, Nₐᵣ denotes the number of atoms linked to atom i by an aromatic bond, and N₁₋₃ denotes the number of atoms separated from atom i by two bonds; and wherein the sum of the charges qᵢ equals a predetermined total molecular charge Q_{M}.

In one embodiment of the invention, the sum of the charges qᵢ in a subgroup j is constrained based on a predetermined total group charge Qᵢ. Preferably, Qᵢ is constrained based on Equation 3:

$${Q}_{j} - δ < {\sum }_{i}^{{N}_{j}} {q}_{i} < {Q}_{j} + δ \qquad Equation 3$$

wherein δ is a fitted parameter and Nj is the number of atoms in subgroup j.

In one embodiment of the invention, eᵢ^{o} and sᵢ^{o} are assigned according to Table 1 wherein “ElecNeg” and “Hard” are the values of eᵢ^{o} and sᵢ^{o} for atom i having the elemental type, number of single bonds, double bonds, triple bonds, formal charge, and special features specified in each row of Table 1:

TABLE 1

| | | | Number of | | | | | Fitted | |
|---|---|---|---|---|---|---|---|---|---|
| | | | Bonds, by type | | | | Special | Parameters | |
| ID | Name | Element | Single | Double | Triple | Charge | Features | ElecNeg | Hard |
| 1 | H1 | H | 1 | 0 | 0 | 0 | No | 27.4 | 73.9 |
| 2 | C3 | C | 4 | 0 | 0 | 0 | No | 30.8 | 78.4 |
| 3 | C2 | C | 2 | 1 | 0 | 0 | No | 33.6 | 76.4 |
| 4 | C1a | C | 0 | 2 | 0 | 0 | No | 37 | 65.3 |
| 5 | C1b | C | 1 | 0 | 1 | 0 | No | 40 | 98.5 |
| 6 | Car | C | 2 | 1 | 0 | 0 | Aromatic | 34.6 | 84.7 |
| 7 | O3 | O | 2 | 0 | 0 | 0 | No | 45.7 | 92.6 |
| 8 | O2 | O | 0 | 1 | 0 | 0 | No | 49.5 | 86.1 |
| 9 | O3n | O | 1 | 0 | 0 | −1 | No | 49.3 | 25 |
| 10 | Oar | O | 2 | 0 | 0 | 0 | Aromatic | 45.9 | 137 |
| 11 | N3 | N | 3 | 0 | 0 | 0 | No | 44 | 87.6 |
| 12 | N3s | N | 3 | 0 | 0 | 0 | Planar | 43.6 | 94.4 |
| 13 | N2 | N | 1 | 1 | 0 | 0 | No | 44 | 72.7 |
| 14 | N1 | N | 0 | 0 | 1 | 0 | No | 57 | 111 |
| 15 | N3p | N | 4 | 0 | 0 | 1 | No | 42.8 | 188 |
| 16 | N2p | N | 2 | 1 | 0 | 1 | No | 37.6 | 41.5 |
| 17 | N1pa | N | 0 | 2 | 0 | 1 | No | 24 | 104 |
| 18 | N1pb | N | 1 | 0 | 1 | 1 | No | 39.4 | 29.7 |
| 19 | Nar3 | N | 3 | 0 | 0 | 0 | Aromatic | 43.4 | 136 |
| 20 | Nar2 | N | 1 | 1 | 0 | 0 | Aromatic | 53 | 102 |
| 21 | Narp | N | 2 | 1 | 0 | 1 | Aromatic | 38.7 | 8.64 |
| 22 | N1m | N | 0 | 1 | 0 | −1 | No | 31.9 | 129 |
| 23 | N2m | N | 2 | 0 | 0 | −1 | No | 28.3 | 20.9 |
| 24 | N2mR | N | 2 | 0 | 0 | −1 | Planar | 43.6 | 0.176 |
| 25 | Cl3 | Cl | 1 | 0 | 0 | 0 | No | 37.6 | 53.5 |
| 26 | F3 | F | 1 | 0 | 0 | 0 | No | 45.2 | 96.8 |
| 27 | Br3 | Br | 1 | 0 | 0 | 0 | No | 40.1 | 75.3 |
| 28 | S3 | S | 2 | 0 | 0 | 0 | No | 37.4 | 69.1 |
| 29 | S3p | S | 3 | 0 | 0 | 1 | No | 31.8 | 93.9 |
| 30 | S4 | S | 2 | 1 | 0 | 0 | No | 35.8 | 93.1 |
| 31 | S6 | S | 2 | 2 | 0 | 0 | No | 31.7 | 83.2 |
| 32 | Sar | S | 2 | 0 | 0 | 0 | Aromatic | 33.8 | 88.9 |
| 33 | S3n | S | 1 | 0 | 0 | −1 | No | 44.5 | 24.8 |
| 34 | S2a | S | 0 | 1 | 0 | 0 | No | 47.5 | 74.3 |
| 35 | P3 | P | 3 | 0 | 0 | 0 | No | 37.9 | 72.5 |
| 36 | P3p | P | 4 | 0 | 0 | 1 | No | 29.6 | 108.5 |
| 37 | P5 | P | 3 | 1 | 0 | 0 | No | 33 | 86.6 |
| 38 | I | I | 1 | 0 | 0 | 0 | No | 41.3 | 109 |
| 39 | Ip | I | 2 | 0 | 0 | 1 | No | 34.1 | 10.8 |

The invention also provides a method of determining a set of resonance forms of a molecule in the context of a molecular calculation comprising:

a. initiating the set of resonance forms by providing a first resonance form of the molecule comprising, for each atom i, an initial formal charge ζᵢ, and for each bond linking atom i with another atom j, an initial bond order bᵢⱼ;

b. for each atom in the molecule, determining whether it is an electron donor, an electron acceptor, or neither a donor nor an acceptor, according to preselected criteria;

c. for every donor atom i, determine an acceptable electron-transfer path to an acceptor atom j according to preselected criteria;

d. generate a new resonance form by electron transfer from donor to acceptor through an acceptable electron-transfer path determined in step c;

e. comparing the resonance form generated in step d with all other resonance forms in the set and, if said resonance form generated in step d is different from all other forms in the set, adding said resonance form generated in step d to the set and repeating steps b-e for said resonance form generated in step d.

In one embodiment of the invention, an acceptable electron transfer path from donor atom i to acceptor atom j according to (c) comprises an acyclic chain of Nₐ atoms and N_{b} bonds linking atoms i and j, wherein Nₐ is odd in number and N_{b} is even in number, and wherein every other bond beginning with the bond linking the donor atom i to the path has a bond order no greater than a predetermined limit based upon the atoms it bonds, and wherein every other bond beginning with the bond linking the acceptor atom j to the path has a bond order no less than 2.

Preferably, the parameters α₁, α₂, α₃, α₄, α₅, β and δ are adjusted to minimize the difference between electrostatic potentials computed with the charges qᵢ obtained from the method and electrostatic potentials computed by ab initio or semi-empirical quantum mechanics calculations for a training set of molecules, or alternatively to minimize the difference between the charges computed with the present method and the charges provided by some other method for a training set of molecules.

### BRIEF DESCRIPTION OF THE DRAWINGS

FIG. 1. Resonance forms of acetate ion

FIG. 2. Resonance forms of a vinylogous ion.

FIG. 3. Flow chart of algorithm for identifying alternate resonance forms of compounds.

FIG. 4. Complex resonance system with donor and acceptor atoms numbered as in initial structure (1) at top. Two generations (second and third rows), in addition to the initial resonance form (first row), are required to identify the full set of 6 resonance forms.

FIG. 5. Resonance forms of an amide group

FIG. 6. Numbering scheme used in Table 6 for compound in FIG. 2.

### DETAILED DESCRIPTION OF THE INVENTION

The present invention addresses the need for a fast, accurate and broadly applicable method of computing accurate partial atomic charges. The method uses the electronegativity equalization approach and is parameterized specifically to reproduce ab initio molecular electrostatic potentials. It also uses a unique algorithm to ensure correct treatment of atoms whose equivalence is recognizable only when alternate resonance forms of a molecule are considered.

1. Method

1.1 Molecules with a Single Important Resonance Form

In one aspect of the method, each atom in the molecule to which partial charges are to be assigned is assigned an atom type, which in another aspect of the invention is based upon its element, bonding pattern, aromaticity, and potentially a small number of additional “special features”. Table 1 lists the atom types in one preferred embodiment of the invention; these types suffice to fully describe the majority of molecules in commercial catalogs of drug-like compounds. Each atom i in the molecule is assigned the initial electronegativity eᵢ^{o} and hardness sᵢ^{o} associated with its type (Table 1). The hardnesses are left at their initial values, but the electronegativities of the atoms are modified to new values eᵢ based upon their locations in the molecule. In another aspect of the invention, the electronegativies are modified according to Equation 2:

$${e}_{i} = {e}_{i}^{o} + {α}_{1} {\sum }_{j}^{{N}_{s}} {S}_{ij} {\vert {e}_{i}^{o} - {e}_{j}^{o} \vert}^{β} + {α}_{2} {\sum }_{k}^{{N}_{d}} {S}_{ik} {\vert {e}_{i}^{o} - {e}_{k}^{o} \vert}^{β} + {α}_{3} {\sum }_{l}^{{N}_{t}} {S}_{il} {\vert {e}_{i}^{o} - {e}_{l}^{o} \vert}^{β} + {α}_{4} {\sum }_{m}^{{N}_{a}} {S}_{im} {\vert {e}_{i}^{o} - {e}_{m}^{o} \vert}^{β} + {α}_{5} {\sum }_{n}^{{N}_{1 - 3}} {S}_{i n} {\vert {e}_{i}^{o} - {e}_{n}^{o} \vert}^{β} \qquad Equation 4$$

wherein

$${S}_{ab} ≡ \frac{{e}_{a}^{o} - {e}_{b}^{o}}{\vert {e}_{a}^{o} - {e}_{b}^{o} \vert} ;$$

and the first 4 sums, respectively, run over atoms linked to atom i with single, double, triple and aromatic bonds, aromaticity taking precedence over bond order; and the 5th sum runs over atoms in a 1-3 bonding relationship to atom i. The α coefficients, along with the exponent β, are parameters that are optimized during the fitting procedure described below. The first 4 modifications of the initial electronegativies here allow for an increase in the polarization of two atoms of unlike electronegativity that are bonded to each other, such as the C and O of a carbonyl group. The fifth term in Equation 2 decreases the transfer of charge between atoms in a 1-3 bonding relationship, and is found empirically to improve the ability of the present model to fit the electrostatic potentials from ab initio quantum calculations.

In yet another aspect of the invention, a “charge group” is then defined around each atom with nonzero formal charge. The charge group comprises the formally charged atom itself and every atom to which it is directly bonded. Each such charge group j is assigned a nominal charge Qj equal to the formal charge of its formally charged atom. If two such charge groups as initially assigned share one or more atoms, then the groups are merged into a single charge group comprising all the atoms of both groups and with a nominal charge equal to the sum of the nominal charges of the two groups. After all such mergers are completed, any charge group whose nominal charge has become zero is eliminated.

Finally, in yet another aspect of the invention, the atomic charges are calculated by minimizing the following function with respect to the charges:

$$E = {\sum }_{i} ( {e}_{i} {q}_{i} + \frac{1}{2} {s}_{i}^{o} {q}_{i}^{2} ) \qquad Equation 1$$

subject to constraints explained later in this paragraph. Intuitively, E may be viewed as an energy that depends upon the atomic charges. The more electronegative an atom—i.e., the greater eᵢ—the more the energy is lowered by movement of negative charge qᵢ to the atom. The greater the hardness sᵢ of an atom, the more it resists accumulation of either positive or negative charge. In still another aspect of the present invention, the minimization of E is subjected to at least one constraint. In one aspect of the invention, the total charge of the molecule Q_{M} must equal the sum of its formal charges:

$${Q}_{M} = {\sum }_{i = 1}^{{N}_{atoms}} {q}_{i} = {\sum }_{j = 1}^{{N}_{grp}} {Q}_{j} \qquad Equation 4$$

Here, qᵢ is the charge on atom i, the sum over i ranges over all atoms in the molecule Nₐₜₒₘₛ, Qⱼ is the nominal charge of charge group j, and j ranges over all N_{grp} charges groups belonging to the molecule. Hence, Equation 4 expresses the constraint on the total charge of the molecule. In another aspect, 2^{N}^{_{grp}} additional constraints are imposed to the effect that the total charge of each charge group jε[1,N_{grp}] must equal the nominal charge Qⱼ associated with the group, plus or minus a “charge bleed” parameter δ which is constant across all groups and is adjusted as part of the overall parameter setting process (Section 2.2). In this manner, up to ±δ electrons of charge is allowed to bleed out of each charge group and into the rest of the molecule. These additional constraints can be written as follows:

$${Q}_{j} - δ < {\sum }_{i}^{{N}_{j}} {q}_{i} < {Q}_{j} + δ \qquad Equation 3$$

Here, the summation over i indicates a sum over all Nⱼ atoms in charge group j

In a preferred embodiment of the present invention, the highly efficient method of Lagrangian multipliers is used to solve the constrained optimization problem posed by Equations 1, 3 and 4. The method of Lagrangian multipliers becomes applicable once it is recognized that the inequality constraints in Equation 3 represent boundaries of the solution space of charges, and that the charges that solve the constrained minimization problem must lie either within, or on, the boundaries. As a consequence, the solution can be obtained by applying Lagrangian multipliers with each charge group's inequality constraints left inactive, or activated as an equality constraint at the upper end of its range (Σ qᵢ=Qⱼ−δ), or activated as an equality constraint at the lower end of its range ((Σ qᵢ=Qⱼ−δ). (The constraint on the total charge Q_{M} is applied in every case.) Thus, 3^{N}^{_{grp}} minimizations are carried out, yielding 3^{N}^{_{grp}} different charge distributions, each corresponding to its own value of E. The resulting charge distributions that do not satisfy the constraints in Equation 3 are discarded, and the correct solution to the constrained optimization problem, as defined in Equations 1, 3 and 4, is the remaining charge distribution corresponding to the lowest value of E. Although this method could become time consuming for a molecule with many charge groups, it is highly efficient for many drug-like molecules.

1.2 Molecules with Multiple Resonance Forms

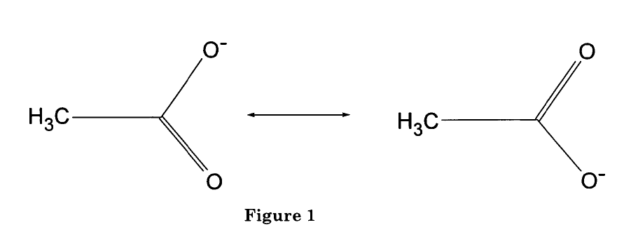

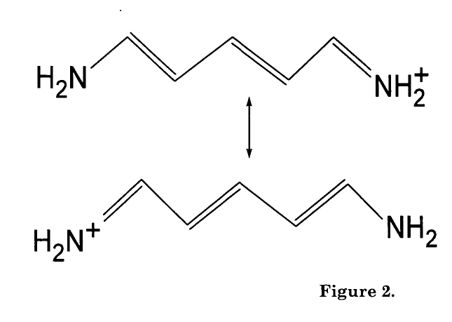

Computer representations of molecules typically store only a single resonance form, but many molecules can be represented in multiple resonance forms, each of which contributes to the electronic structure. For example, the two resonance forms of the acetate molecule in FIG. 1 contribute equally to its charge distribution, so the two oxygens are chemically equivalent and must be assigned equal partial charges. Computing charges based upon the bonding pattern of only one resonance form would lead, incorrectly, to the assignment of different atomic charges to the two oxygens. Because the two oxygens are close to each other, and a carboxylate is a standard chemical group, many charging algorithms handle carboxylate groups correctly by recognizing them as a special case and treating them accordingly. However, a more general treatment of resonance forms is essential in more complex cases. For example, the two nitrogens in the vinylogous compound in FIG. 2 do not form a recognized chemical group. Nonetheless, from the two resonance forms shown in the figure, it is clear that the two nitrogens are chemically equivalent and must be assigned equal partial atomic charges. Another aspect of the present invention is a method of identifying alternate resonance forms and using them in the calculation of partial atomic charges. Changes in resonance form can be divided into two types. The first type involves a formal electron transfer one atom to another, and the second type involves changes in bond order around an aromatic ring without any net electron transfer between atoms. Only the first type of resonance change must be dealt with explicitly in the present charging method, because the second type does not affect atom typing as exemplified in Table 1.

1.2.1 Method for Identification of Alternate Donor/Acceptor Resonance Forms.

In one aspect of the invention, the algorithm takes as input a single resonance form of the molecule, with an explicit integer bond order for each bond and an explicit formal charge for each atom. In another aspect of the invention, the algorithm uses predetermined criteria for identifying electron-donor and electron-acceptor atoms within the molecule, and for assigning a predefined resonance energy to each donor and acceptor atom. Table 2 provides an example embodiment of such criteria and energies. Here, for example, an oxygen of zero formal charge and having one bond of order 2 is an electron acceptor and has a resonance energy of zero, in arbitrary energy units. Upon accepting an electron, it is converted into its conjugate donor, an oxygen of formal charge −1 with one bond of order 1 and resonance energy 5. This conjugate donor type is also listed in Table 2, along with other donors and acceptors, and the correspondences between conjugate pairs. This table can optionally be expanded to include additional donors and acceptors, and the method can also be adjusted by modifying the values of the resonance energies in the table.

TABLE 2

| | Ele- | Formal | Number | Bond | Donor/ | En- | ID of |
|---|---|---|---|---|---|---|---|
| ID | ment | charge | of bonds | orders | Acceptor | ergy | Conjugate |
| 1 | O | 0 | 1 | 2 | A | 0 | 2 |
| 2 | O | −1 | 1 | 1 | D | 5 | 1 |
| 3 | S | 0 | 1 | 2 | A | 0 | 4 |
| 4 | S | −1 | 1 | 1 | D | 5 | 3 |
| 5 | N | 1 | 3 | 2, 1, 1 | A | 5 | 6 |
| 6 | N | 0 | 3 | 1, 1, 1 | D | 0 | 5 |
| 7 | N | 0 | 2 | 2, 1 | A | 0 | 8 |
| 8 | N | −1 | 2 | 1, 1 | D | 5 | 7 |
| 9 | N | 0 | 1 | 3 | A | 0 | 10 |
| 10 | N | −1 | 1 | 2 | D | 5 | 9 |

In still a further aspect of the invention, a new resonance form is generated when an electron-donor atom formally transfers an electron to an electron-acceptor atom, causing the donor to become its conjugate acceptor and the acceptor to become its conjugate donor (see conjugate IDs in Table 2), while the orders of the bonds connecting the donor and acceptor along a single path change in a prescribed manner. In another aspect of the invention, the bonds along the path connecting the donor and acceptor change as follows: the orders rise by 1 for the odd-numbered bonds in the sequence, starting with the bond to the donor, and the orders of the even numbered bonds in the sequence fall by 1. In order for these changes in bond order to be permitted, the path connecting the donor and acceptor must contain an odd number of atoms and thus an even number of bonds. In addition, the changes in bond order must not raise the order of a bond above 3 (2 in the case of oxygen), and no bond whose order needs to be lowered by 1 can start off as a single bond, because then lowering its order would break it. If a donor and acceptor are connected by a path meeting these criteria, then an alternate resonance form exists and is generated as just described.

In still another aspect of the invention, the procedure for identifying the formal electron transfers that are possible for a given resonance form begins by using the donor/acceptor criteria, such as those in Table 2, to identify all atoms that are of donor or acceptor type. In yet another aspect of the invention, for each donor atom, a search is carried out for any path of atoms that connects to an acceptor atom and that meets the criteria for an electron transfer path given above. In still another aspect of the invention, if such a path exists, a formal electron transfer is carried out from the donor to the acceptor along the path as described above, to generate an alternate resonance form.

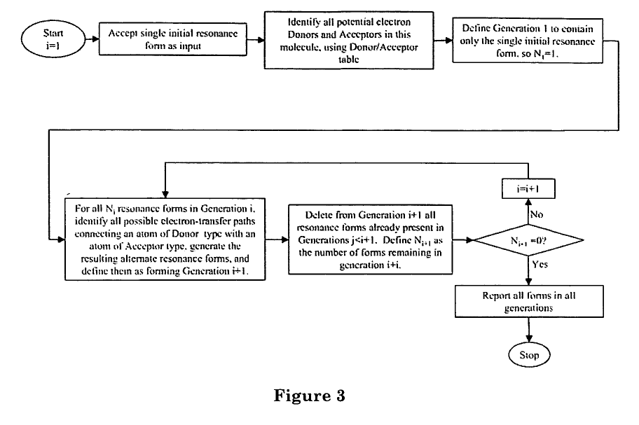

In yet another aspect of the present invention, all possible alternative resonance forms of the input molecule are discovered by the following method, which is also diagrammed in FIG. 3. The alternative resonance forms are generated in successive generations, starting with the solitary input form which is the first generation i=1. Generations i>1 may include multiple resonance forms, and the total number of generations that will be generated is not known at the outset. Starting with generation i=1, and then repeating for successive generations i>1, the procedure described in the next paragraph is used to identify and carry out all possible formal electron transfers for every form in generation i, thus creating a new generation i=i+1 of resonance forms. All forms generated in this way that do not already exist in any previous generation are saved, but repeats are discarded. In yet another aspect of the invention, two resonance forms are considered identical when they possess exactly the same set of electron-donor atoms and electron-acceptor atoms. For example, if a given atom i exists in the form of an electron-donor in one resonance form, and in the form of the conjugate electron-accept (see Table 2) in another form, the two forms are considered distinct. In still another aspect of the method, successive generations of resonance forms are created until a generation is reached that contains no new forms, at which point the algorithm stops.

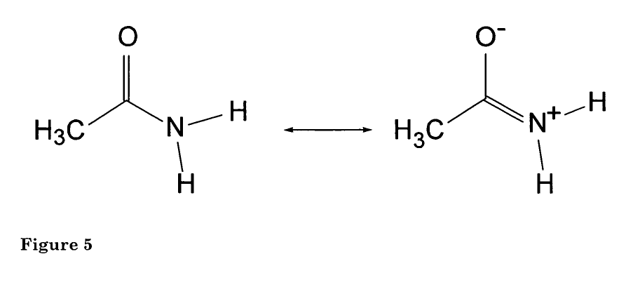

Not all resonance forms contribute equally to the electronic structure of a molecule. For example, although an amide group has two resonance forms (FIG. 5), the form in which both oxygen and nitrogen carry formal charges contributes less to the electronic structure than that in which both atoms are formally neutral. In another aspect of the present invention, the more important resonance forms are identified and used preferentially. In yet another aspect of the invention, the differences in importance are identified as follows. Each type of donor and acceptor atom is assigned a resonance energy, in arbitrary units, for example as listed in the donor/acceptor definition table (Table 2), and the energy of a given resonance form of the molecule is computed as the sum of the energies of its donors and acceptors. In a preferred embodiment of the present invention, only the resonance forms having the lowest resonance energy over all resonance forms in the set generated above are provided in the output of the procedure.

Note that the procedure for identifying all resonance forms, described above and diagrammed in FIG. 3, does not eliminate the high-energy resonance forms until the end of the procedure. This is because it is sometimes necessary to go through a high-energy form in order to identify a low-energy form. FIG. 3 shows an example. All the resonance forms in the figure have four formally charged atoms and hence an energy of 4×5=20 arbitrary energy units (see Table 2), except for form 2, which has 2 additional formal charges for an energy of 30 energy units. Although 2 is a high-energy form that will be discarded when determining the average electronegativities and hardnesses of the atoms (see previous paragraph), form 2 is required as a step in the identification of form 5, which is of energy 20 and hence will contribute to the averages in Equations 5.

1.2.2. {xe “Averaging of electronegativities and hardnesses over resonance forms”}Averaging of electronegativities and hardnesses over resonance forms.

In a preferred embodiment of the method for computing partial atomic charges, only those resonance forms k=(1,2, . . . , Nᵣ) at the lowest energy level—for example both forms of a carboxylate, but only the form of an amide that is low in energy because it has no formal charges—are used to compute the atomic charges. Atom types, such as those in Table 1, are assigned to each such form k and Equation 2 can be used to compute the electronegativity, eᵢₖ, of each atom i in resonance form k. Hardnesses, s^{o}ᵢₖ, can also be assigned without modification from Table 1. In still another aspect of the present invetion, these electronegativities and hardnesses are averaged over the Nᵣ low-energy resonance forms to yield an electronegativity and a hardness for each atom i that reflects the contributions of all the low-energy resonance forms, as shown in Equation 5:

$${e}_{i} = \frac{1}{{N}_{r}} {\sum }_{k = 1}^{{N}_{r}} {e}_{ik} \\ {s}_{i} = \frac{1}{{N}_{r}} {\sum }_{k = 1}^{{N}_{r}} {s}_{ik} \qquad Equation 5$$

This procedure yields a single averaged value for the electronegativity and hardness of each atom for use in Equation 1. Note that, after this average is taken, the two oxygens of a carboxylate have equal electronegativities and equal hardnesses, as is physically appropriate. It is envisioned that other averaging methods could also be used. For example, it would be possible to compute partial atomic charges separately for each low-energy resonance form and then average the charges.

1.2.3 {xe” Merging of Charge Groups for Multiple Resonance Forms”} Merging of Charge Groups for Multiple Resonance Forms

As described above (Section 1.1) for molecules with only a single resonance form, a charge group is defined around each formally charged atom, and a constraint is applied to keep most of the formal charge within this group of atoms (Equation 3). For molecules with multiple low-energy resonance forms, however, a formal charge can move from one atom to another, depending upon the resonance form. In another aspect of the invention, this is addressed by creating a separate charge group for each atom that bears formal charge in any resonance form, and assigning fractional nominal charges depending upon the fraction of resonance forms in which the atom is formally charged. For example, the molecule in FIG. 2 is assigned two charge groups of nominal charge 0.5, each comprising a nitrogen atom, 2 hydrogen atoms, and a carbon atom. Charge groups that overlap by sharing at least one atom are then merged as described in Section 1.1. Thus, the carboxylate in FIG. 1 is preliminarily assigned two charge groups of charge −0.5, each comprising an oxygen atom and a carbon atom. However, because the groups share the carboxylate carbon atom, they are merged to a single charge group of nominal charge −1. Furthermore, if the methyl group of the acetate ion in FIG. 1 were replaced by an ammonium group, which has a formal charge of +1 on the nitrogen atom, then the preliminary charge group associated with the ammonium would include the carboxylate carbon. As a consequence, the ammonium and carboxylate charge groups would overlap, leading to a merger of 3 charge groups with zero net charge, so all the charge groups would be eliminated as described in Section 1.1.

1.3 Optimization of Parameters

In another aspect of the present invention, the parameters of the charging model are adjusted to maximize the accuracy of the resulting charges. In a preferred embodiment, accuracy is judged by the ability of the resulting charges to reproduce electrostatic potentials computed by ab initio quantum mechanics around a set of representative molecules. In another embodiment, accuracy is judged by the agreement of partial charges from the present method with reference partial charges from another method for a set of reference molecules. In a preferred embodiment, the following 85 parameters are adjusted: the values of e^{o} and so for each atom type in Table 1; the global parameters α₁, α₂, α₃, α₄, α₅ and β in Equation 2; and 6 in Equation 3. In another aspect of the invention, the error in the electrostatic potential computed with a set of partial charges for molecule i is defined as

$${D}_{i} ≡ ( \frac{{\sum }_{j = 1}^{{n}_{i}^{φ}} {( {φ}_{ij}^{quantum} - {φ}_{ij}^{model} )}^{2}}{{n}_{i}^{φ}} ) \qquad Equation 6$$

where nᵢ^{φ} is the number of sampling points around molecule i, φᵢⱼ^{quantum} is the electrostatic potential at point j around molecule i from the quantum calculation, and φᵢⱼ^{model} is the electrostatic potential at sampling point j of molecule i. The error for all N molecules in a set of representative molecules is computed as

$$D = {( \frac{{\sum }_{i = 1}^{N} {D}_{i}^{2}}{N} )}^{\frac{1}{2}} \qquad Equation 7$$

computed based upon the present charging model using Coulomb's law in vacuo. A computational global optimization algorithm can be used to automatically adjust the parameters of the model to minimize the value of D.

2. Application and Evaluation

2.1 Parameterization, Accuracy, and Comparison with Other Methods

In a sample application of the present invention, 284 molecules with molecular weight ranging between 17 and 374 Daltons, with a mean of 199 Daltons, were used to parameteriz and test the method. These compounds were divided into a parameterization set of Nₚₐᵣ=253 molecules and a smaller test set of Nₜₑₛₜ=31 molecules, where both sets contained at least one instance of each atom type in Table 1. HyperChem Lite (Release 1.0, Hypercube, Inc., 1996) was used to set up each molecule, and the program GAMESS (Schmidt, M. W. et al., J. Comp. Chem. 1993, 14:1347-1363) was then used to further minimize the energy with respect to conformation—i.e., to generate a stable, low-energy conformation—and to compute electrostatic potentials at sampling points around each molecule. All quantum calculations were done at the 6-31G* level, except that the SBKJC effective core potential was used for iodine. The electrostatic potentials were computed with the CHELPG method (Breneman, C. M. et al., J. Comput. Chem. 1990, 11:361), as implemented in GAMESS, with RMAX=3 Angstroms and DELR=0.8 Angstroms, where RMAX is the maximum distance of any point to the closest atom and DELR is the distance between neighboring sampling points. The resulting values of the atomic electronegativities and hardnesses (e^{o} and s^{o}, respectively) are listed in Table 1, and Table 3 lists the optimized values of the global parameters parameters α₁, α₂, α₃, α₄, α₅ and β in Equation 2, and δ in Equation 3.

TABLE 3

| Param | Value |
|---|---|
| α1 | 1 |
| α2 | 1.74 |
| α3 | 1.67 |
| α4 | 0.86 |
| α5 | 0.057 |
| β | 1.378 |
| δ | 0.545 |

These optimized parameters were tested first by computing the measure of error defined in Equation 7, but now using the Nₜₑₛₜ=31 test molecules, rather than the Nₚₐᵣ=253 molecules in the parameterization set. The parameters were further assessed by using them with the present method to compute partial atomic charges for a variety of small molecules for which published partial charges are available from other methods. The parameters were also used to compute charges for the 20 common amino acids, including several variant ionization states, and for the four common deoxyribonucleotides, because well accepted force field parameters, including partial charges, are available for these biochemical components.

After parameterization, the errors are very low for both the parameterization (D=3.44 kcal/(mol-electron)) and test sets (Dₜₑₛₜ=4.72 kcal/(mol-electron)) of molecules described above. One may compare these values with the CHELPG charges which, although they are mathematically optimal for reproducing the electrostatic potentials, are not suitable for use in molecular modeling force fields because they are slow to compute, vary with conformation, and differ for chemically equivalent atoms. CHELPG charges yield overall errors Dᵢ of D=1.93 and D=2.20 kcal/(mol-electron) for the parameterization and test sets respectively.

TABLE 4

| Compound | CHELPG | VC/2003 | MMFF | OPLS | QEq | GM |
|---|---|---|---|---|---|---|
| Imidazole | 2.08 | 3.8 | 4.3 | 4.03 | 9.89 | 9.84 |
| Imidazolium | 1.43 | 5.13 | 4.22 | 6.59 | 8.68 | 4.7 |
| Methylamine | 1.99 | 2.79 | 2.65 | 2.5 | 3.95 | 5.55 |
| Methyl- | 1.09 | 1.14 | 1.67 | 2.87 | n/a | 10.1 |
| ammonium | | | | | | |
| Acetic acid | 0.78 | 1.59 | 2.37 | 2.45 | 7.03 | 5.52 |
| Acetate | 0.91 | 1.87 | 3.5 | 2.54 | 5.92 | 6.33 |
| Pyridine | 1.83 | 2.38 | 4.8 | 4.79 | 3.88 | 3.93 |
| Aminobenzene | 1.91 | 2.96 | 3.88 | 3.17 | 6.34 | 6.37 |
| Water | 1.6 | 2.36 | 1.82 | 1.69 | 2.53 | 6.92 |
| Methanol | 1.31 | 1.98 | 1.87 | 2.01 | 5.4 | 3.93 |
| Acetone | 0.78 | 2.03 | 2.34 | 1.87 | 3.82 | 3.36 |
| Dimethyl ether | 1.09 | 1.37 | 2.25 | 1.62 | n/a | 1.31 |
| Mean | 1.4 | 2.45 | 2.97 | 3.01 | 5.74 | 5.66 |

The accuracy of the present method in reproducing ab initio quantum potentials is compared with that of several other charging models in Table 43. Published atomic charges from various models were used to compute values of Dᵢ (Equation 6), based upon the ab initio electrostatic potentials. These are compared with the values of Dᵢ from CHELPG and from the present method, which are listed as VC/2003 charges. The present method, which is applicable to a broad range of compounds and uses 85 adjustable parameters, yields more accurate potentials (lower values of Dᵢ in Table 4) than any other method tested here except for CHELPG which, as noted above, is not suitable for a force field. The MMFF (Halgren, T. A. J. Comput. Chem. 1996, 17;520-552.7) and OPLS (Jorgensen, W. L. et al., J. Am. Chem. Soc. 1988, 110:1657-1666) charges are also quite accurate, but the MMFF charging method requires a large number (N˜500) of parameters, and does not, to our knowledge, handle complex resonance forms automatically. OPLS parameters, although well optimized, are not available for a broad variety of molecules. The QEq and Gasteiger-Marsili (GM) electronegativity equalization methods yield inaccurate electrostatic potentials, as assessed by the ab initio ESPs.

TABLE 5

| | | | | AM1- |
|---|---|---|---|---|
| Compound | CHELPG | VC/2003 | RESP | BCC |
| Imidazole | 2.08 | 3.8 | 4.37 | 3.05 |
| Methanol | 1.31 | 1.98 | 1.94 | 1.88 |
| Glucose | 1.23 | 2.42 | 4.57 | 3.73 |
| Indole | 2.16 | 2.88 | 2.82 | 3.68 |
| Aspirin | 1.7 | 2.46 | 2.44 | 2.93 |
| Mean | 1.7 | 2.71 | 3.23 | 3.05 |

The AM1-BCC method of calculating partial atomic charges (Jakalian, A. et al. J. Comput. Chem. 2000, 21;132-146) uses semi-empirical quantum mechanics to generate an initial set of charges, and then corrects them by adding bond charge corrections designed to improve the agreement with reference charges from the RESP method (Bayly, C. I. et al., J. Phys. Chem. 1993, 97;10269-10280), which is based upon ab initio quantum mechanics. AM1-BCC achieves high accuracy at intermediate computational cost. Table 5 compares the accuracy of AM1-BCC and RESP charges with that of VC/2003 and CHELPG charges by showing values of Di for compounds for which published data are available for RESP and AM1-BCC. The results indicate that VC/2003 charges are as accurate as AM1-BCC, despite the fact that VC/2003 charges rely on fewer parameters than AM1-BCC and can be computed much more rapidly.

The VC/2003 charges from the present method are very similar to those of the well-accepted CHARMM (MacKerell, A. et al. J. Phys. Chem. B 1998, 102:3586-3616) and AMBER94 (Cornell, W. et al., J. Am. Chem. Soc. 1995, 117:5179-5197) force fields for the amino acids and nucleic acids: the root-mean-square deviation of VC/2003 charges from CHARMM, and AMBER94 are all within 0.10±0.01 electrons for the amino acids, and 0.138±0.016 electrons for the nucleotides. It should be noted that CHARMM and AMBER charges are available for only a limited set of compounds, whereas VC/2003 charges can be generated rapidly for a wide range of compounds.

2.2 Examples of Molecules with Multiple Resonance Forms

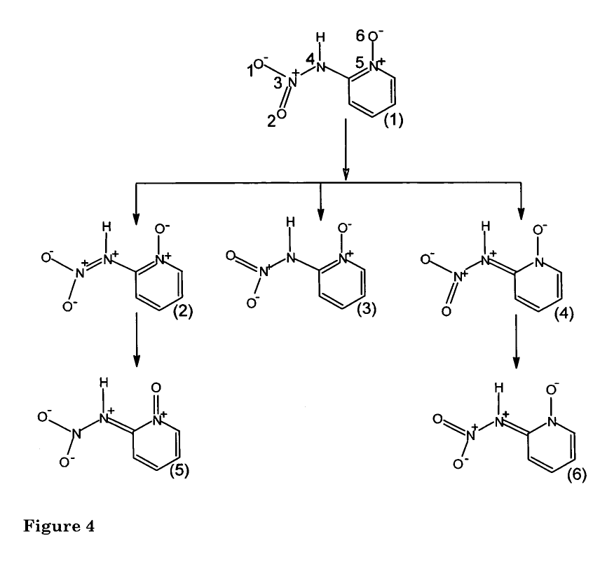

The present method of generating resonance forms efficiently treats even complex resonance systems that might be difficult to analyze by hand. Thus, it correctly identifies both resonance forms of the compound in FIG. 2 and of other vinylogous compounds, as well as the more complicated system shown in FIG. 4. Note that resonance form 5 in FIG. 4 cannot be derived by a single formal electron transfer starting from the initial conformation 1, but only via an electron transfer starting from one of the second generation of resonance forms. Moreover, resonance form 5 can be reached only via an intermediate resonance form, 2, which is of high energy relative to the other forms. These examples show that identification of alternative donor/acceptor resonance forms is a nontrivial task that is best accomplished by the use of a systematic algorithm.

TABLE 6

| Atom(s) | VC/2003 | GM | Quanta |
|---|---|---|---|
| 1 | 0.367 | 0.155 | 0.15 |
| 1′ | 0.367 | 0.352 | 0.25 |
| 2 | 0.367 | 0.155 | 0.15 |
| 2′ | 0.367 | 0.352 | 0.25 |
| 3 | −0.641 | −0.404 | −0.3 |
| 3′ | −0.641 | 0.01 | −0.4 |
| 4 | 0.135 | −0.005 | −0.2 |
| 4′ | 0.135 | 0.154 | 0.55 |
| 5 | 0.133 | 0.08 | 0.17 |
| 5′ | 0.133 | 0.097 | 0.17 |
| 6 | −0.052 | −0.046 | 0 |
| 6′ | −0.052 | −0.031 | −0.2 |
| 7 | 0.143 | 0.063 | 0.12 |
| 7′ | 0.143 | 0.064 | 0.17 |
| 8 | −0.046 | −0.059 | 0 |
| 9 | 0.143 | 0.062 | 0.12 |

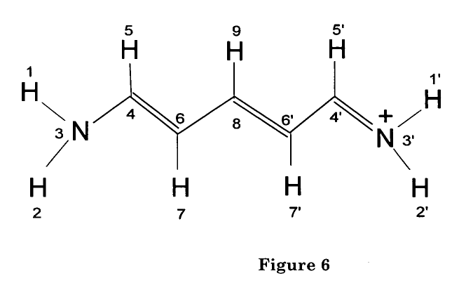

Correctly averaging over resonance forms is essential in order to equalize the charges of chemically equivalent atoms, such as the oxygens in a carboxylate group or the widely separated nitrogens in the vinylogous system in FIG. 2. Table 6 compares the atomic charges of this compound from VC/2003 with those from Gasteiger-Marsili (GM) as implemented in the program Babel, and with the charges from the program Quanta. Neither of these two methods detects alternate resonance forms, so both yield markedly incorrect charges for this compound. Atom numbering is provided in FIG. 6.

2.3 Efficiency and Applicability

The present charging method is suitable for processing large numbers of compounds because it is fast and broadly applicable. Thus, in one implementation, the method requires about 0.45 s per compound in the December 2002 Maybridge HTS compound catalog (Maybridge PLC) on a 2.26 GHz Pentium 4 processor, and is able to process all but 8 of the approximately 56,000 compounds.

### REFERENCES

1. Weiner, S. J.; Kollman, P. A.; Case, D. A.; Singh, U. C.; Ghio, C.; Alagona, G.; Profeta, S.; Weiner, P. A new force field for molecular mechanical simulation of nucleic acids and proteins. J. Am. Chem. Soc. 1984, 106:765-784.

2. MacKerell, Jr., A. D.; Wiokiewicz-Kuczera, J.; Karplus, M. An all-atom empirical energy function for the simulation of nucleic acids J. Am. Chem. Soc. 1995, 117:11946-11975.

3. Momany, F. Determination of partial atomic charges from ab initio molecular electrostatic potentials—application to formamide, methanol, and formic acid. J. Phys. Chem. 1978, 82;592.

4. Bayly, C. I.; Cieplak, P.; Cornell, W. D.; Kollman, P. A. A well-behaved electrostatic potential based method using charge-restraints for deriving charges: The RESP model. J. Phys. Chem. 1993, 97;10269-10280.

5. Momany, F. A.; Rone, R. Validation of the general-purpose Quanta3.2/CHARMM force-field J. Comput. Chem. 1992, 13;888-900.

6. Bush, B. L.; Bayly, C. I.; Halgren, T. A. Consensus bond-charge increments fitted to electrostatic potential or field of many compounds: application to MMFF94 training set. J. Comput. Chem. 1999, 20:1495-1516.

7. Jakalian, A.; Bush, B. L.; Jack, D. B.; Bayly, C. I. Fast efficient generation of high-quality atomic charges. AM1-BCC Model: I. Method J. Comput. Chem. 2000, 21;132-146.

8. Storer, J. W.; Giesen, D. J.; Cramer, C. J.; Truhlar, D. G. Class IV charge models: a new semiempirical approach in quantum chemistry. J. Comput. Aided Mol. Des. 1995, 9:87.

9. Dewar, M. J. S.; Zoebisch, E. G.; Healy, E. F.; Stewart, J. J. P. AM1: a new general purpose quantum mechanical molecular model. J. Am. Chem. Soc. 1985, 107;3902-3909.

10. Sanderson, R. T. An interpretation of bond lengths and a classification of bonds. Science 1951, 114: 670.

11. Gasteiger, J.; Marsili, M. Iterative partial equalization of orbital electronegativity—a rapid access to atomic charges. Tetrahedron 1980, 36:3219-3228.

12. Halgren, T. A. Merck molecular force field. I. Basis, form, scope parameterization, and performance of MMFF94 J. Comput. Chem. 1996, 17;520-552.

13. Rappe, A. K.; Goddard III, W. A. Charge equilibration method for molecular dynamics simulations. J. Phys. Chem. 1991, 95, 3358-3363.

14. Bultinck, P.; Langenaeker, W.; Lahorte, P.; De Proft, F.; Geerlings, P.; Van Alsenoy, C.; Tollenaere, J. P. The electronegativity equalization method I: Parameterization and validation for atomic charge calculation. J. Phys. Chem. A 2002, 106:7895-7901.

15. Schmidt, M. W.; Baldridge, K. K.; Boatz, J. A.; Elbert, S. T.; Gordon, M. S.; Jensen, J. H.; Koseki, S.; Matsunaga, N.; Nguyen, K. A.; Su, S. J.; Windus, T. L.; Dupuis, M.; Montgomery, J. A. general atomic and molecular electronic-structure system J. Comp. Chem. 1993, 14:1347-1363.

16. Breneman, C. M.; Wiberg, K. B. Determining atom-centered monopoles from molecular electrostatic potentials—the need for high sampling density in formamide conformational-analysis J. Comput. Chem. 1990, 11:361.

17. Jorgensen, W. L.; Tirado-Rives, J. The OPLS Potential Function for Proteins. Energy minimizations for crystals of cyclic peptides and crambin. J. Am. Chem. Soc. 1988, 110:1657-1666.

18. MacKerell, A. et al. All-atom empirical potential for molecular modeling and dynamics studies of proteins. J. Phys. Chem. B 1998, 102:3586-3616.

19. Cornell, W.; Cieplak, P.; Bayly, C.; Gould, I.; Merz, Jr., K.; Ferguson, D.; Spellmeyer, D.; Caldwell, T. F. J.; P. A.,; Kollman, J. Am. Chem. Soc. 1995, 117:5179-5197.

We claim:

1. A method of assigning charges to atoms in a molecule in the context of carrying out a molecular calculation, comprising, for each atom i in the molecule, assigning an electrical charge qᵢ by minimizing a function E according to Equation 1 as follows:
$$E = {\sum }_{i} ( {e}_{i} {q}_{i} + \frac{1}{2} {s}_{i}^{o} {q}_{i}^{2} ) \qquad Equation 1$$
wherein eᵢ is the electronegativity of atom i, sᵢ^{o} is the hardness of atom i and the summation runs over all atoms in the molecule and wherein eᵢ is calculated according to Equation 2
$${e}_{i} = {e}_{i}^{o} + {α}_{1} {\sum }_{j}^{{N}_{s}} {S}_{ij} {\vert {e}_{i}^{o} - {e}_{j}^{o} \vert}^{β} + {α}_{2} {\sum }_{k}^{{N}_{d}} {S}_{ik} {\vert {e}_{i}^{o} - {e}_{k}^{o} \vert}^{β} + {α}_{3} {\sum }_{l}^{{N}_{t}} {S}_{il} {\vert {e}_{i}^{o} - {e}_{l}^{o} \vert}^{β} + {α}_{4} {\sum }_{m}^{{N}_{ar}} {S}_{im} {\vert {e}_{i}^{o} - {e}_{m}^{o} \vert}^{β} - {α}_{5} {\sum }_{n}^{{N}_{1 - 3}} {S}_{i n} {\vert {e}_{i}^{o} - {e}_{n}^{o} \vert}^{β} \qquad Equation 2$$
wherein
$${S}_{ab} ≡ \frac{{e}_{a}^{o} - {e}_{b}^{o}}{\vert {e}_{a}^{o} - {e}_{b}^{o} \vert} ,$$
and wherein eᵢ^{o} is a predetermined initial electronegativity for atom i; α₁, α₂, α₃, α₄, α₅ and β are fitted parameters; Nₛ denotes the total number of atoms j linked to atom i by a single bond, N_{d} denotes the total number of atoms k linked to atom i by a double bond, Nₜ denotes the total number of atoms l linked to atom i by a triple bond, Nₐᵣ denotes the number of atoms linked to atom ᵢ by an aromatic bond, and N₁₋₃ denotes the number of atoms separated from atom i by two bonds; and wherein the sum of the charges qᵢ equals a predetermined total molecular charge Q_{M}.

2. The method of claim 1 wherein the sum of the charges qᵢ in a subgroup j of atoms is constrained based on a predetermined total group charge Qⱼ.

3. The method of claim 2 wherein Qⱼ is constrained based on Equation 3:
$${Q}_{j} - δ < {\sum }_{i}^{{N}_{j}} {q}_{i} < {Q}_{j} + δ \qquad Equation 3$$
wherein δ is a fitted parameter and Nⱼ is the number of atoms in subgroup j.

4. The method of claim 1 wherein eᵢ^{o} and sᵢ^{o} are assigned according to Table 1 wherein “ElecNeg” and “Hard” are the values of eᵢ^{o} and sᵢ^{o} for atom i having the elemental type, number of single bonds, double bonds, triple bonds, formal charge, and special features specified in each row of Table 1:
TABLE 1

| | | | Number of | | | | | | |
|---|---|---|---|---|---|---|---|---|---|
| | | | Bonds, | | | | | Fitted | |
| | | | by type | | | | Special | Parameters | |
| ID | Name | Element | Single | Double | Triple | Charge | Features | ElecNeg | Hard |
| 1 | H1 | H | 1 | 0 | 0 | 0 | No | 27.4 | 73.9 |
| 2 | C3 | C | 4 | 0 | 0 | 0 | No | 30.8 | 78.4 |
| 3 | C2 | C | 2 | 1 | 0 | 0 | No | 33.6 | 76.4 |
| 4 | C1a | C | 0 | 2 | 0 | 0 | No | 37 | 65.3 |
| 5 | C1b | C | 1 | 0 | 1 | 0 | No | 40 | 98.5 |
| 6 | Car | C | 2 | 1 | 0 | 0 | Aromatic | 34.6 | 84.7 |
| 7 | O3 | O | 2 | 0 | 0 | 0 | No | 45.7 | 92.6 |
| 8 | O2 | O | 0 | 1 | 0 | 0 | No | 49.5 | 86.1 |
| 9 | O3n | O | 1 | 0 | 0 | −1 | No | 49.3 | 25 |
| 10 | Oar | O | 2 | 0 | 0 | 0 | Aromatic | 45.9 | 137 |
| 11 | N3 | N | 3 | 0 | 0 | 0 | No | 44 | 87.6 |
| 12 | N3s | N | 3 | 0 | 0 | 0 | Planar | 43.6 | 94.4 |
| 13 | N2 | N | 1 | 1 | 0 | 0 | No | 44 | 72.7 |
| 14 | N1 | N | 0 | 0 | 1 | 0 | No | 57 | 111 |
| 15 | N3p | N | 4 | 0 | 0 | 1 | No | 42.8 | 188 |
| 16 | N2p | N | 2 | 1 | 0 | 1 | No | 37.6 | 41.5 |
| 17 | N1pa | N | 0 | 2 | 0 | 1 | No | 24 | 104 |
| 18 | N1pb | N | 1 | 0 | 1 | 1 | No | 39.4 | 29.7 |
| 19 | Nar3 | N | 3 | 0 | 0 | 0 | Aromatic | 43.4 | 136 |
| 20 | Nar2 | N | 1 | 1 | 0 | 0 | Aromatic | 53 | 102 |
| 21 | Narp | N | 2 | 1 | 0 | 1 | Aromatic | 38.7 | 8.64 |
| 22 | N1m | N | 0 | 1 | 0 | −1 | No | 31.9 | 129 |
| 23 | N2m | N | 2 | 0 | 0 | −1 | No | 28.3 | 20.9 |
| 24 | N2mR | N | 2 | 0 | 0 | −1 | Planar | 43.6 | 0.176 |
| 25 | Cl3 | Cl | 1 | 0 | 0 | 0 | No | 37.6 | 53.5 |
| 26 | F3 | F | 1 | 0 | 0 | 0 | No | 45.2 | 96.8 |
| 27 | Br3 | Br | 1 | 0 | 0 | 0 | No | 40.1 | 75.3 |
| 28 | S3 | S | 2 | 0 | 0 | 0 | No | 37.4 | 69.1 |
| 29 | S3p | S | 3 | 0 | 0 | 1 | No | 31.8 | 93.9 |
| 30 | S4 | S | 2 | 1 | 0 | 0 | No | 35.8 | 93.1 |
| 31 | S6 | S | 2 | 2 | 0 | 0 | No | 31.7 | 83.2 |
| 32 | Sar | S | 2 | 0 | 0 | 0 | Aromatic | 33.8 | 88.9 |
| 33 | S3n | S | 1 | 0 | 0 | −1 | No | 44.5 | 24.8 |
| 34 | S2a | S | 0 | 1 | 0 | 0 | No | 47.5 | 74.3 |
| 35 | P3 | P | 3 | 0 | 0 | 0 | No | 37.9 | 72.5 |
| 36 | P3p | P | 4 | 0 | 0 | 1 | No | 29.6 | 108.5 |
| 37 | P5 | P | 3 | 1 | 0 | 0 | No | 33 | 86.6 |
| 38 | I | I | 1 | 0 | 0 | 0 | No | 41.3 | 109 |
| 39 | Ip | I | 2 | 0 | 0 | 1 | No | 34.1 | 10.8 |

5. A method according to claim 1 wherein, for each atom i, eᵢ and sᵢ are calculated as average values based on a set of resonance forms of the molecule.

6. The method of claim 5 wherein the set of resonance form is generated by:
a. initiating the set of resonance forms by providing a first resonance form of the molecule comprising, for each atom i, an initial formal charge ζᵢ, and for each bond linking atom i with another atom j, an initial bond order bᵢⱼ;
b. for each atom in the molecule, determining whether it is an electron donor, an electron acceptor, or neither a donor nor an acceptor, according to preselected criteria;
c. for every donor atom i, determining an acceptable electron-transfer path to an acceptor atom j according to preselected criteria;
d. generating a new resonance form by electron transfer from donor to acceptor through an acceptable electron-transfer path determined in step c;
e. comparing the resonance form generated in step d with all other resonance forms in the set and, if said resonance form generated in step d is different from all other forms in the set, adding said resonance form generated in step d to the set and repeating steps b-e for said resonance form generated in step d.

7. The method of claim 6 wherein an acceptable electron transfer path from donor atom i to acceptor atom j according to (c) comprises an acyclic chain of Nₐ atoms and Nb bonds linking atoms i and j, wherein Nₐ is odd in number and N_{b} is even in number, and wherein every other bond beginning with the bond linking the donor atom i to the path has a bond order no greater than a predetermined limit based upon the atoms it bonds, and wherein every other bond beginning with the bond linking the acceptor atom j to the path has a bond order no less than 2.

8. The method of claim 7 wherein generating a new resonance form by electron transfer from donor to acceptor through an acceptable electron-transfer path in step (d) comprises incrementing the charge of the electron donor atom i by 1; decrementing the charge of the electron acceptor atom j by 1; incrementing by 1 the bond order of every other bond along the electron transfer path, beginning with the bond linking the donor atom i to the path; and decrementing by 1 the bond order of every other bond along the electron transfer path beginning with the bond linking the acceptor atom j to the path.

9. A method of determining a set of resonance forms of a molecule in the context of a molecular calculation comprising:
a. initiating the set of resonance forms by providing a first resonance form of the molecule comprising, for each atom i, an initial formal charge ζᵢ, and for each bond linking atom i with another atom j, an initial bond order bᵢⱼ;
b. for each atom in the molecule, determining whether it is an electron donor, an electron acceptor, or neither a donor nor an acceptor, according to preselected criteria;
c. for every donor atom i, determining an acceptable electron-transfer path to an acceptor atom j according to preselected criteria;
d. generating a new resonance form by electron transfer from donor to acceptor through an acceptable electron-transfer path determined in step c;
e. comparing the resonance form generated in step d with all other resonance forms in the set and, if said resonance form generated in step d is different from all other forms in the set, adding said resonance form generated in step d to the set and repeating steps b-e for said resonance form generated in step d.

10. The method of claim 9 wherein an acceptable electron transfer path from donor atom i to acceptor atom j according to (c) comprises an acyclic chain of Nₐ atoms and N_{b} bonds linking atoms i and j, wherein Nₐ is odd in number and N_{b} is even in number, and wherein every other bond beginning with the bond linking the donor atom i to the path has a bond order no greater than a predetermined limit based upon the atoms it bonds, and wherein every other bond beginning with the bond linking the acceptor atom j to the path has a bond order no less than 2.

11. The method of claim 10 wherein generating a new resonance form by electron transfer from donor to acceptor through an acceptable electron-transfer path in step (d) comprises incrementing the charge of the electron donor atom i by 1; decrementing the charge of the electron acceptor atom j by 1; incrementing by 1 the bond order of every other bond along the electron transfer path, beginning with the bond linking the donor atom i to the path; and decrementing by 1 the bond order of every other bond along the electron transfer path beginning with the bond linking the acceptor atom j to the path.

12. The method of claim 1 wherein the parameters α₁, α₂, α₃, α₄, α₅ and β and the values of eᵢ^{o} and sᵢ^{o} in Equation 2 have been adjusted to minimize the difference between electrostatic potentials computed with the charges qᵢ obtained from the method and electrostatic potentials computed by ab initio or semi-empirical quantum mechanics calculations for a training set of molecules.

13. The method of claim 1 wherein the parameters α₁, α₂, α₃, α₄, α₅ and β and the values of eᵢ^{o} and sᵢ^{o} in Equation 2 have been adjusted to minimize the difference between the charges qᵢ obtained from the method and predetermined reference charges for a training set of molecules.

14. The method of claim 4 wherein the parameters α₁, α₂, α₃, α₄, α₅, and the values of eᵢ^{o} and sᵢ^{o} in Table 1 have been adjusted to minimize the difference between electrostatic potentials computed with the charges qᵢ obtained from the method and electrostatic potentials computed by ab initio or semi-empirical quantum mechanics calculations for a training set of molecules.

15. The method of claim 4 wherein the parameters α₁, α₂, α₃, α₄, α₅, β, and the values of eᵢ^{o} and sᵢ^{o} in Table 1 have been adjusted to minimize the difference between the charges qᵢ obtained from the method and predetermined reference charges for a training set of molecules.

16. The method of claim 5 wherein the parameters α₁, α₂, α₃, α₄, α₅ and β and the values of eᵢ^{o} and sᵢ^{o} in Equation 2 have been adjusted to minimize the difference between electrostatic potentials computed with the charges qᵢ obtained from the method and electrostatic potentials computed by ab initio or semi-empirical quantum mechanics calculations for a training set of molecules.

17. The method of claim 5 wherein the parameters α₁, α₂, α₃, α₄, α₅ and β and the values of eᵢ^{o} and sᵢ^{o} in Equation 2 have been adjusted to minimize the difference between the charges qᵢ obtained from the method and predetermined reference charges for a training set of molecules.
